(19) United States
(12) Patent Application Publication
(10) Pub. No.: US 2024/0022123 A1
(43) Pub. Date: Jan. 18, 2024

(54) STATOR FOR AN ELECTRIC MACHINE AND PROCESS FOR MAKING SUCH STATOR

(71) Applicant: MAVEL EDT S.P.A., PONT SAINT MARTIN AOSTA (IT)

(72) Inventors: Luca FAVRE, PONT SAINT MARTIN (AO) (IT); Davide BETTONI, PONT SAINT MARTIN (AO) (IT)

(21) Appl. No.: 18/258,330

(22) PCT Filed: Dec. 31, 2020
(86) PCT No.: PCT/IT2020/000089

§ 371 Date: Jun. 20, 2023

(51) Int. Cl. H02K 1/16

(52) U.S. Cl. CPC H02K 1/165

(57) ABSTRACT

A stator (15) for an electric machine is described, comprising an outer annular portion (35) and an inner portion (25) bounded by a cylindrical inner wall (32) of the stator (15) which is configured to house a rotor (5), the internal portion (25) comprising a plurality of slots (14, 24) inside which the electric winding is made, at least one of the slots (14, 24) having an asymmetrical conformation; a process for manufacturing the stator (15) and an electric machine comprising the stator (15) are also described.

### BACKGROUND OF THE INVENTION

### 1) Field of the Invention

The present invention refers to a stator for an electric machine and to a process for manufacturing such a stator. In particular, the invention refers to a stator for a rotating electric machine with open or closed slots comprising a winding made using a metal conductor.

### 2) Background Art

Known electric machines include a fixed part, the stator, and a moving part, the rotor, arranged coaxially one inside the other. Typically, the rotor comprises a pack of laminations fixed on a rotation shaft, and is inserted inside the stator, which includes an electric winding capable of generating a magnetic field that causes the rotor to rotate.

The stator is generally annular in shape and includes a plurality of radial slots, inside which the electric winding is obtained.

Electric machines are known, for example a synchronous reluctance electric motor assisted by permanent magnets, comprising a stator with open slots; also known are electric machines with a stator with closed slots which provides a wall for closing the stator slots at the rotor, to reduce the problems caused by the torque ripple, with the vibrations and noise associated therewith.

For making the electric windings of the stators, it is known to use electric conductors made using strips or continuous wires, or copper strips that are bent in the central part to form hairpin-shaped strips, to be inserted in the stator slots.

In known stators, both with open slots and with closed slots, there is a need to optimize efficiency and operation of the electric machine in a desired operating condition, for example with a certain direction of rotation of the rotor.

### SUMMARY OF THE INVENTION

Object of the present invention is solving these problems by means of a stator for an electric machine, which allows improving the efficiency and operation of the electric machine in a desired operating condition, without complicating the production process.

The aforementioned and other objects and advantages of the invention, which will appear from the following description, are achieved with a stator for an electric machine and a process for the construction of such a stator as described in the independent claims.

Preferred embodiments and non-trivial variants of the present invention are the subject matter of the dependent claims.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention as appears from the attached claims.

### BRIEF DESCRIPTION OF THE DRAWINGS

The present invention will be better described by some preferred embodiments thereof, provided as a non-limiting example, with reference to the attached drawings, in which:

FIG. 1 shows a perspective view of an internal portion of a stator of an electric machine according to a first embodiment of the invention;

FIG. 2 shows a perspective view of an external portion of a stator of an electric machine according to a first embodiment of the invention;

FIG. 3 shows a perspective view of a stator of an electric machine according to a first embodiment of the invention;

FIG. 4 shows a perspective view of a stator of an electric machine according to a second embodiment of the invention;

FIG. 5 shows a schematic front view of an internal part of a stator according to a first embodiment of the invention; and

FIG. 6 shows a perspective view of a rotor and a stator of an electric machine according to the invention.

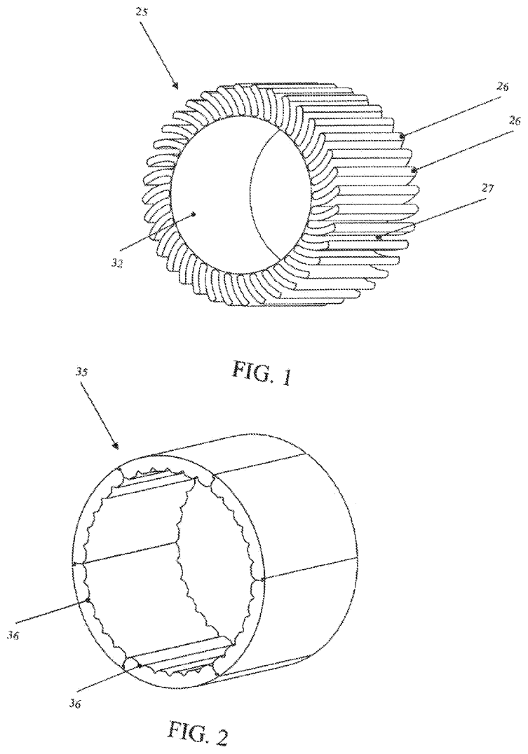

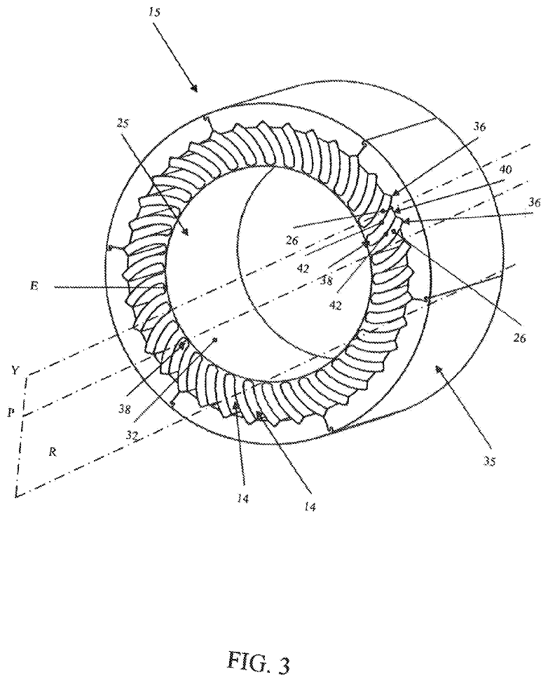

### DETAILED DESCRIPTION OF PREFERRED EMBODIMENTS

With reference to the figures, the stator 15 for an electric machine according to the invention will be described below, and comprises an external annular portion 35 and an internal portion 25, delimited by a cylindrical internal wall 32 of the stator 15 which is configured to house a rotor 5, the internal portion 25 comprising a plurality of slots 14, 24 inside which the electric winding is made, arranged along the direction of a longitudinal Y axis of the stator 15, spaced by a space 27, at least one of the slots 14, 24 having an asymmetrical conformation; preferably, each of the slots 14, 24 has an asymmetrical conformation; preferably, the Y axis is the longitudinal, central axis of symmetry of the stator 15.

In particular, the slot 14, 24 has an asymmetrical conformation with respect to a plane R passing through the longitudinal Y axis of the stator 15 and through a centreline P of the slot 14, 24 in correspondence with the internal wall 32.

The slot 14, 24 of the stator 15 comprises two side walls 42 made in the internal portion 25 of the stator, and an upper wall 40 made in the external annular portion 35.

In a preferred embodiment of the invention, the side walls 42 of the slot 14, 24 are asymmetrical, in particular with respect to the plane R passing through the longitudinal Y axis of the stator 15 and the centreline P of the slot 14, 24 at the inner wall 32; preferably, the side walls 42 of the slot 14, 24 are curved or concave, and more preferably have the concavity made in such a way as to optimize the efficiency or operation of the electric machine in a desired operating direction; for example, the concavity faces in a specific direction with respect to a preferred rotation direction Z of the rotor 5. The stator 15 of the invention preferably comprises a continuous winding made with a strip 11 or a wire inserted inside the slots 14, 24.

In a first embodiment of the invention, the stator 15 comprises a plurality of closed slots 14 arranged, preferably equidistant from each other, along the cylindrical internal wall 32 of the stator 15, and each slot 14 comprises a bottom wall 38 arranged along the direction of the longitudinal Y axis of the stator 15, in proximity to the internal wall 32 at a distance E from the internal wall 32.

Each closed slot 14 of the stator 15 is composed of two side walls 42 and of a bottom wall 38 made in the internal portion 25 of the stator, and of an upper wall 40 made in the external annular portion 35; for example, the bottom wall 38 has a semi-circular or arched shape.

These closed slots 14 have an asymmetrical conformation with respect to a plane R passing through the Y axis and the centreline P of the bottom wall 38.

The stator 15 with closed slots according to the first embodiment of the invention preferably comprises a plurality of longitudinal teeth 26 made in the internal portion 25 of the stator, spaced apart by a space 27 configured to form the lower part of the closed slots 14, and a plurality of seats 36 made in the outer annular portion 35, complementary to the teeth 26 and configured to fit together with the inner portion 25 of the stator by means of a reciprocal sliding movement of the inner portion 25 and of the outer annular portion 35, in order to form the closed slots 14 and stator 15.

Preferably, each closed slot 14 of the stator 15 according to the first embodiment of the invention is composed of two side walls 42 of two adjacent teeth 26 made in the internal portion 25 of the stator, of the bottom wall 38 connecting the two adjacent teeth 26 and of an upper wall 40 formed by a wall for connecting two adjacent seats 36 made in the outer annular portion 35 of the stator.

The stator 15 with closed slots according to the first embodiment of the invention preferably comprises a continuous winding made with a strip 11 or a wire inserted inside the closed slots 14 of the stator 15, preferably wrapping the strip 11 on the teeth 26 by means of a relative rotation of the internal portion 25 with respect to the strip 11.

In the first embodiment of the stator 15 with closed slots according to the invention, the external annular portion 35 of the stator is composed of interlocked sectors, for example by providing a guide that allows the sectors to be assembled by sliding them in the direction of the Y axis longitudinal stator 15.

The process for making a closed-slot stator with continuous winding according to the first embodiment of the invention includes the following steps:
a step of folding on a plane at least one conductor, preferably a strip to make at least one strip 11, in a single piece, the strip 11 comprising a plurality of first sectors configured to be inserted inside slots 14 closed by one stator 15 and connected to each other by a plurality of second bending sectors configured to remain outside the closed slots 14 of the stator 15;
a step of preparing the stator 15, the stator 15 comprising an internal portion 25 comprising a plurality of longitudinal teeth 26 spaced by a space 27 configured to form the lower part of the closed slots 14 of the stator, and a second external annular stator part 35, comprising a plurality of seats 36 complementary to the teeth 26 of the internal portion 25 of the stator and configured to interlock with the internal portion so as to form the closed slots 14 and the stator
a step of carrying out the winding on the internal stator portion 25 of the conductor, preferably of the at least one strip 11 by positioning the first sectors of the strip 11 in the spaces 27 included between the teeth 26; in particular, the strip 11 is wound on the internal portion 25 of the stator so as to mesh it between the teeth 26 of the internal portion 25, similarly to how a chain is engaged on the teeth of a gear, by means of a relative rotation of the internal stator portion 25 with respect to the strap 11; in particular, the number of rotations is equal to the number of hollow turns; during this rotation, the curved or concave shape of the side walls 42 of the teeth 26 facilitates the insertion of the strap 11 in the closed slots 14, in order to fill them optimally.

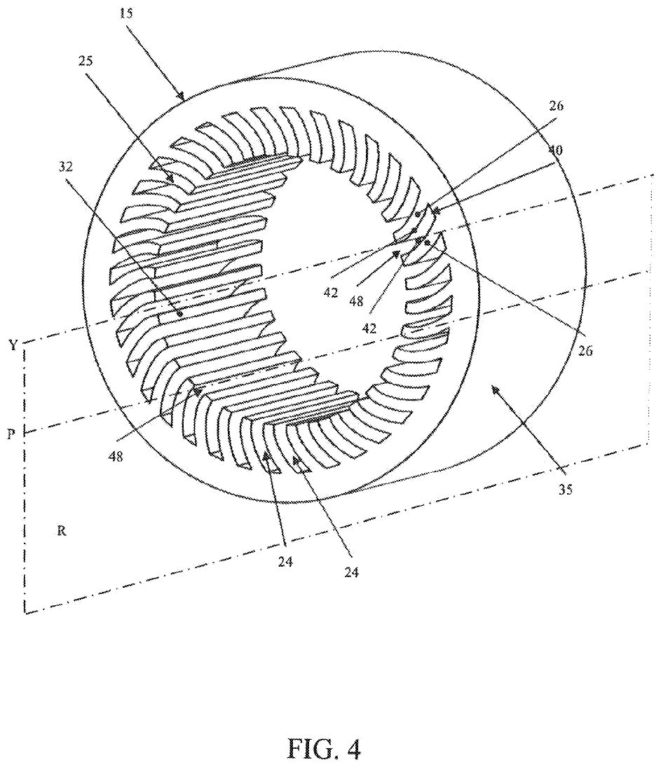

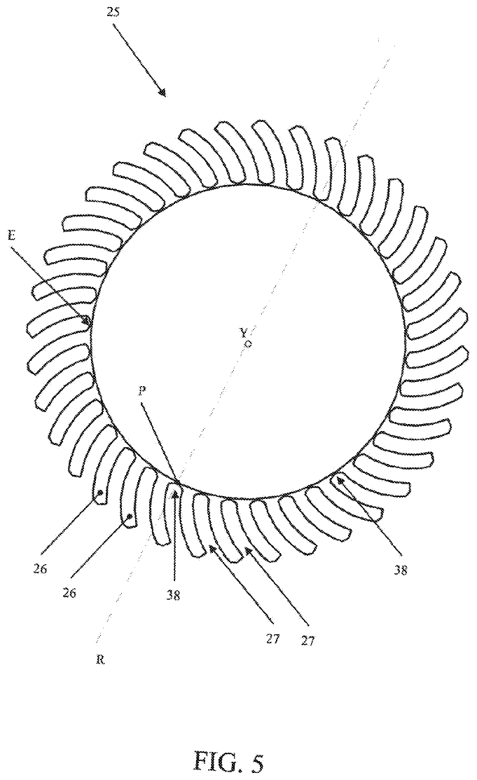

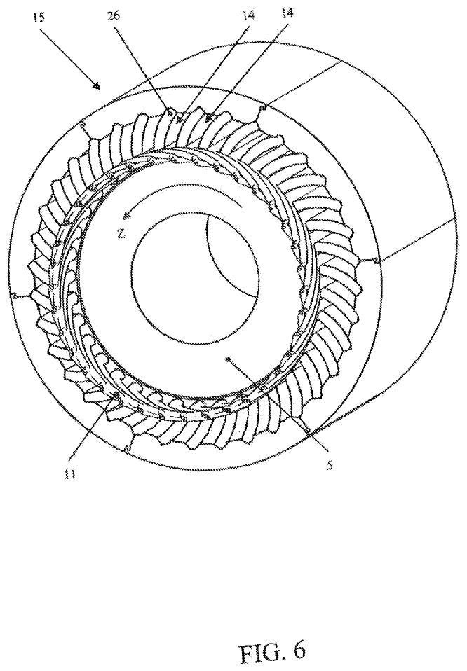

In a second embodiment of the invention shown in FIG. 4, the stator 15 comprises a plurality of open slots 24 arranged, preferably equidistant from each other, along the cylindrical internal wall 32 of the stator 15 and each slot 24 comprises an opening 48 arranged in the direction of the longitudinal Y axis of the stator 15, in correspondence with the inner wall 32; preferably the opening 48 extends over the entire width of the stator 15.

Each open slot 24 of the stator 15 is formed by two side walls 42 made in the internal portion of the stator, by an opening 48 and by an upper wall 40 made in the external annular portion 35.

The open slots 24 have an asymmetrical conformation with respect to a plane R passing through the Y axis and the centreline P of the opening 48 in correspondence with the internal wall 32.

The stator 15 with open slots according to the second embodiment of the invention preferably comprises a plurality of longitudinal teeth 26 made in the internal portion 25 of the stator, spaced from a space configured to make the open slots 24.

Preferably, each open slot 24 of the stator 15 according to the second embodiment of the invention is composed of two side walls 42 of two adjacent teeth 26 made in the internal portion 25 of the stator, and of an upper wall 40 formed by a wall of connection of two adjacent teeth 26.

The stator 15 with open slots according to the second embodiment of the invention preferably comprises a continuous winding made with a strip 11 or a wire inserted inside the open slots 24 of the stator 15, preferably by wrapping the strip 11 on the teeth 26 by means of a relative rotation of the stator 15 with respect to the strip 11.

The process for making a stator with open slots with continuous winding according to the second embodiment of the invention includes the following steps:
a step of bending on a plane at least one conductor, preferably a strip to make at least one strip 11 in a single piece, the strip 11 comprising a plurality of first sectors configured to be inserted inside open slots 24 of a stator 15 and connected to each other by a plurality of second bending sectors configured to remain outside the open slots 24 of the stator 15;
a step of preparing the stator 15, the stator 15 comprising an internal portion 25 comprising a plurality of longitudinal teeth 26 spaced by a space configured to form the open slots 24 of the stator, and a second external annular stator part 35;
a step of carrying out the winding on the internal portion 25 of the stator of the at least one conductor, preferably a strip 11 by positioning the first sectors of the strip 11 in the spaces between the teeth 26; in particular, the strip 11 is wound on the internal portion 25 of the stator so as to mesh it between the teeth 26 of the internal portion 25, similarly to how a chain is engaged on the teeth of a gear, by means of a relative rotation of the internal portion 25 of the stator with respect to strap 11; in particular, the number of rotations is equal to the number of hollow turns; during this rotation the curved or concave shape of the side walls 42 of the teeth 26 facilitates the insertion of the strap 11 in the open slots 24, in order to fill them optimally.

Advantageously, the stator for a rotating electric machine with open or closed slots according to the invention makes it possible to facilitate the insertion of the winding in the stator slots to fill them in an optimal way, and to optimize the efficiency and operation of the electric machine in a desired operating condition, for example with a certain direction of rotation of the rotor.

1. Stator for an electric machine comprising an outer annular portion and an inner portion bounded by a cylindrical inner wall of the stator which is configured to house a rotor, said internal portion comprising a plurality of slots inside which the electric winding is obtained, at least one of said slots having an asymmetrical conformation.

2. Stator for an electric machine according to claim 1, characterized in that the slot has an asymmetrical conformation with respect to a plane passing through a longitudinal axis of the stator and through a centreline of the slot in correspondence with the internal wall.

3. Stator for an electric machine according to claim 1, characterized in that the slot comprises two asymmetrical side walls made in the internal portion of the stator, and an upper wall made in the outer annular portion.

4. Stator for an electric machine according to claim 3, characterized in that the side walls of the slot are asymmetrical with respect to the plane passing through the longitudinal axis of the stator and through the centreline of the slot in correspondence with the internal wall.

5. Stator for an electric machine according to claim 3, characterized in that the side walls of the slot are curved or concave.

6. Stator for an electric machine according to claim 5, characterized in that the side walls of the slot have the concavity facing in a specific direction with respect to a preferred rotation direction of the rotor to optimize the efficiency or operation of the electric machine in a desired direction of operation.

7. Stator for an electric machine according to claim 1, characterized in that each slot comprises a bottom wall arranged in the direction of the longitudinal axis of the stator in proximity of the internal wall, said slot having an asymmetrical conformation with respect to a plane passing through the axis and the centreline of the bottom wall.

8. Stator for an electric machine according to claim 1, characterized in that each slot comprises an opening arranged in the direction of the longitudinal axis of the stator in correspondence with the internal wall, said slot having an asymmetrical conformation with respect to a plane passing through the axis and the centreline of the opening.

9. Process for manufacturing a stator with continuous winding according to claim 1, characterized in that it comprises the following steps:
a step of bending on a plane at least one conductor in a single piece;
a step of preparing the stator, said stator comprising an internal portion which comprises a plurality of longitudinal teeth spaced from a space configured to form the slots of the stator, and a second part of an outer annular stator;
a step of making the winding on the internal portion of the stator of said at least one conductor, in the spaces between the teeth by means of a relative rotation of the internal portion of the stator with respect to the conductor.

10. Electric machine comprising a stator according to claim 1.
